(19) United States
(12) Patent Application Publication
(10) Pub. No.: US 2006/0005817 A1
(43) Pub. Date: Jan. 12, 2006

(54) Fuel fume gas trap device and air intake system including the same

(76) Inventor: Nam Kyun Paek, Seoul (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/024,864

(22) Filed: Dec. 28, 2004

(30) Foreign Application Priority Data
Jul. 6, 2004 (KR) 10-2004-0052424

(51) Int. Cl. F02M 33/02; F02B 77/08

(52) U.S. Cl. 123/520; 123/198 DB

(57) ABSTRACT

An actuator actuates a fuel fume trap to open and close an intake air passage to prevent reverse flow of fuel fumes through the intake air passage connected to a downstream side of an air cleaner.

### CROSS-REFERENCE TO RELATED APPLICATIONS

This application claims priority of Korean Application No. 10-2004-0052424, filed on Jul. 6, 2004, the disclosure of which is incorporated herein by reference.

### FIELD OF THE INVENTION

Generally, the present invention relates to a fuel fume trap device and an air intake system including the same. More particularly, the present invention relates to a fuel fume trap device and an air intake system including the same for preventing emission of fuel fumes (evaporation fuel in gaseous form).

### BACKGROUND OF THE INVENTION

Generally, fuel fumes are mainly composed of hydrocarbon (HC) and may be a factor contributing to pollution if the fumes are emitted to the atmosphere. Therefore, for preventing the emission of fuel fumes, a conventional canister and a purge control solenoid valve for controlling the canister are mounted between a fuel tank and an air intake system. According to such a scheme, the emission of the fuel fumes is effectively prevented during an engine operation.

However, while the engine is stopped, the fuel fumes in the engine flow reversely through an air intake system and a fuel system and are emitted to the atmosphere. Therefore, for minimizing the emission of fuel fumes through the air intake system and the fuel system while the engine is stopped, a trap including a carbon material for filtering the fuel evaporation gas may be mounted in an intake air passage.

In the case that the trap is mounted in an intake air passage, although the emission of the fuel fumes may be effectively prevented while the engine is stopped, the engine performance may still be reduced because flow of the intake air experiences resistance while passing through the intake air passage during engine operation. In addition, in the case that carbon material breaks off, the engine may be damaged by the broken carbon materials flowing into the engine.

The information disclosed in this Background of the Invention section is only for enhancement of understanding of the background of the invention and should not be taken as an acknowledgement or any form of suggestion that this information forms the prior art that is already known in this country to a person of ordinary skill in the art.

### SUMMARY OF THE INVENTION

The motivation for the present invention is to provide a fuel fume trap device and an air intake system including the same having non-limiting advantages of preventing emission of fuel fumes. An exemplary fuel fume trap device and an air intake system including the same according to an embodiment of the present invention includes: an air duct; an air cleaner connected to a downstream side of the air duct for purifying intake air; and a fuel fume trap device for blocking reverse flowing of fuel fumes through an intake air passage connected to a downstream side of the air cleaner, wherein the fuel fume trap device comprises a fuel fume trap mounted in the intake air passage so as to selectively open and close the intake air passage and an actuator for actuating the fuel fume trap.

In a further embodiment, the actuator actuates the fuel fume trap so as to open the intake air passage during engine operation, and actuates the fuel fume trap so as to close the intake air passage when the engine is stopped.

In another further embodiment, the actuator actuates the fuel fume trap on the basis of signals transmitted from an engine control unit or an ignition switch.

In a further embodiment, a fuel fume trap device for blocking reverse flowing of fuel fume through an intake air passage of an engine comprises a fuel fume trap mounted in the intake air passage so as to selectively open and close the intake air passage and an actuator for actuating the fuel fume trap.

In another further embodiment, the actuator actuates the fuel fume trap so as to open during engine operation, and actuates the fuel fume trap so as to close the intake air passage when the engine is stopped.

In another further embodiment, the actuator actuates the fuel fume trap on the basis of signals transmitted from an engine control unit or an ignition switch.

### BRIEF DESCRIPTION OF THE DRAWINGS

The accompanying drawings illustrate exemplary embodiments of the present invention, and, together with the description, serve to explain the principles of the present invention, wherein:

FIG. 1 shows an intake system according to an embodiment of the present invention; and

FIG. 2 shows a fuel evaporation gas trap device according to an embodiment of the present invention.

### DETAILED DESCRIPTION OF THE EMBODIMENTS

An embodiment of the present invention will hereinafter be described in detail with reference to the accompanying drawings.

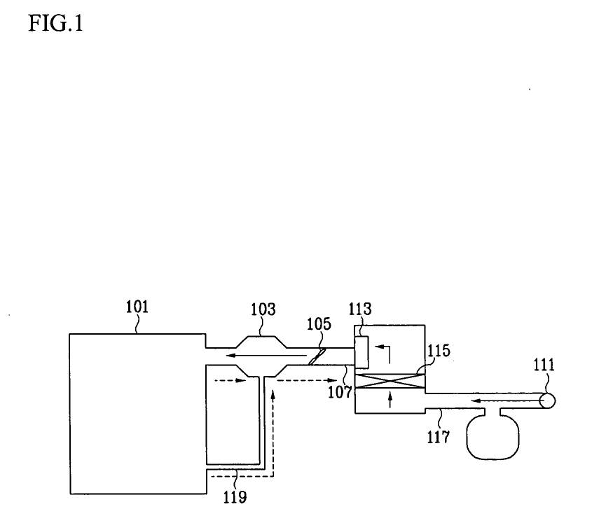

FIG. 1 is a drawing showing an intake system according to an embodiment of the present invention. As shown in FIG. 1, an intake system according to an embodiment of the present invention includes: an air duct 117; an air cleaner 115; and a fuel fumes gas trap device 113. The air cleaner 115 is connected to a downstream side of the air duct 117 and purifies intake air.

An intake air passage 107 is connected to a downstream side of the air cleaner 115 and the fuel evaporation gas trap device 113 is mounted between the air cleaner 115 and the intake air passage 107. Therefore, the fuel evaporation trap device 113 prevents reverse flow of the fuel evaporation gas through the intake air passage 107. As shown in FIG. 1, the air that has been introduced into an intake hole 111 passes the air duct 117, is then purified at the air cleaner 115 that is connected to a downstream side of the air duct 117.

The air purified at the air cleaner 115 is supplied to an engine 101 by sequentially passing through the fuel fume gas trap device 1 13, the intake air passage 107, a throttle valve 105, and a plenum 103 (refer to the solid line arrows in FIG. 1).

In addition, the intake air is mixed with fuel injected from a fuel injector (not shown) mounted in the intake air passage 107 and then the intake air is supplied to the engine 101. The fuel fumes may be formed by fuel remaining in a combustion chamber or a crankcase evaporating.

While the engine is stopped, the fuel fumes tend to be emitted to the atmosphere by flowing reversely from the engine 101 or a positive crankcase ventilation (PCV) hose and passing through the intake air passage 107 in a direction reverse with the direction through which the intake air passes (refer to the dotted line arrows in FIG. 1). At that time, the fuel fume gas trap device 113 blocks an emission of the fuel evaporation gas to the atmosphere by a reverse flow through the intake air passage 107.

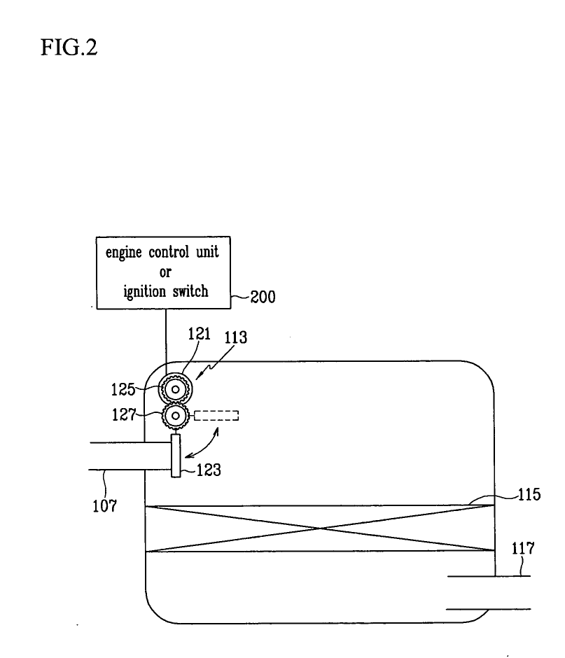

FIG. 2 shows a fuel evaporation gas trap device according to an embodiment of the present invention. As shown in FIG. 2, the fuel fume trap device 113 includes an actuator 121 and a fuel fume trap 123. For example, the actuator 121 can be realized as a motor.

The fuel evaporation trap 123 is mounted to the intake air passage 107 such that the fuel evaporation trap 123 can selectively open or close the intake air passage 107 and the actuator 121 actuates the fuel evaporation trap 123. The actuator 121 includes a drive gear 125. The fuel evaporation gas trap 123 is connected to a driven gear 127 geared with the drive gear 125. Therefore, the drive gear 125 and the driven gear 127 are actuated by an actuation of the actuator 121 and the fuel fume trap 123 can rotate along the direction of the arrows in FIG. 2.

A solid line of the fuel fume trap 123 illustrates a state that the fuel evaporation gas trap 123 closes the intake air passage 107 and a dotted line of the fuel fume trap 123 illustrates another state in which the fuel fume trap 123 opens the intake air passage 107. That is, the intake air passage 107 is selectively opened or closed by the rotation of the fuel fume trap 123 by the actuator 121.

The fuel fume trap 123 is exemplarily mounted in the intake air passage 107, however, it may be mounted in another place of the air intake system e.g., the air duct. The actuator 121 can actuate the fuel fume trap 123 on the basis of signals transmitted from any control unit of a vehicle.

According to an embodiment of the present invention, the actuator 121 actuates the fuel fume trap 123 on the basis of signals transmitted from an engine control unit (ECU) 200. On the other hand, the actuator 121 may also actuate the fuel fume trap 123 on the basis of signals transmitted from an ignition switch 200. That is, in the case of the engine operation, the actuator 121 actuates the fuel fume trap 123 so as to open the intake air passage 107, on the basis of signals transmitted from the ECU 200.

In addition, when the engine stops, the actuator 121 actuates the fuel fume trap 123 so as to close the intake air passage 107.

When the engine 101 stops, if the fuel fume trap 123 closes the intake air passage 107, the emission of the fuel fume to the atmosphere can be prevented.

On the other hand, at the time when the engine 101 starts, if the fuel fume trap 123 opens the intake air passage 107, the engine effectively operates because the fuel fume trap 123 does not produce resistance to an air flow.

The engine control unit (ECU) 200 may include one or more processors activated by a predetermined program, and the predetermined program can be programmed to include a set of instructions for enabling the actuator 121 to perform the above described operations according to an embodiment of this invention.

According to an embodiment of the present invention the fuel fume trap can prevent the fuel fumes from flowing in reverse from the engine without causing resistance to the intake air introduced into the engine. In addition, damage caused by a breakdown of a carbon material in the fuel fume trap can be prevented.

In addition, manufacturing costs can be reduced because the fuel fume trap can be manufactured for less than prior devices. Furthermore, air pollution can be prevented because the fuel fumes are more effectively prevented from escaping into the atmosphere.

While this invention has been described in connection with what is presently considered to be the most practical exemplary embodiments, it is to be understood that the invention is not limited to the disclosed embodiments, but, on the contrary, is intended to cover various modifications and equivalent arrangements included within the spirit and scope of the appended claims.

1. An air intake system comprising:
an air duct;
an air cleaner connected to a downstream side of the air duct for purifying intake air; and
a fuel fume trap device for blocking reverse flow of fuel fumes through an intake air passage connected to a downstream side of the air cleaner,
wherein the fuel fume trap device comprises:
a fuel fume trap mounted to an end portion of the intake air passage so as to selectively open and close the intake air passage, and
an actuator for actuating the fuel fume trap.

2. The system of claim 1, wherein the actuator actuates the fuel fume trap to open the intake air passage during operation of an engine, and actuates the fuel fume trap to close the intake air passage when the engine is operating.

3. The system of claim 2, wherein the actuator actuates the fuel fume trap based on signals transmitted from an engine control unit or an ignition switch.

4. A fuel fume trap device for blocking reverse flow of fuel fumes through an intake air passage of an engine, the fuel fume trap device comprising:
a fuel fume trap mounted to an end portion of the intake air passage so as to selectively open and close the intake air passage; and
an actuator for actuating the fuel fume trap.

5. The device of claim 4, wherein the actuator actuates the fuel fume trap to open during operation of an engine, and actuates the fuel evaporation gas trap to close the intake air passage when the engine is stopped.

6. The device of claim 5, wherein the actuator actuates the fuel fume trap based on signals transmitted from an engine control unit or an ignition switch.
